(19) United States
(12) Patent Application Publication
(10) Pub. No.: US 2026/0220298 A1
(43) Pub. Date: Jul. 30, 2026

(54) OUTPUT GUARDRAILS

(71) Applicant: Walmart Apollo, LLC, Bentonville, AR (US)

(72) Inventors: Aditya Venkat Kumarakrishnan, Forest Hills, NY (US); Dinesh Sardana, Wilton, CT (US)

(21) Appl. No.: 19/448,005

(22) Filed: Jan. 13, 2026

Related U.S. Application Data
(60) Provisional application No. 63/750,924, filed on Jan. 29, 2025.

(51) Int. Cl. G06F 21/62; G06F 16/334

(52) U.S. Cl. CPC G06F 21/6245; G06F 16/3347

(57) ABSTRACT

Example implementations relate to output guardrails in automated systems. In an example, a user input from a user device is received by a first trained model and an initial output is generated in response to the first trained model receiving the user input from the user device. The initial output is compared to a set of target response elements, each of the target response elements include at least a portion of a machine generated utterance. A revised output is generated by applying a mitigation logic selected based on the at least one target response element and the revised output is transmitted to the user device when the output of the first trained machine learning model includes at least one target response element. The initial output is transmitted to the user device when the initial output does not include at least one target element.

### CROSS-REFERENCE TO RELATED APPLICATIONS

This application claims priority to Application No. 63/750,924 filed on January 29, 2025 and entitled “Output Guardrails,” the entire contents of which are incorporated herein by reference.

### TECHNICAL FIELD

This application relates generally to automated interaction systems and, more particularly, to automated detection and mitigation of outputs for automated interaction systems.

### BACKGROUND

Some machine learning systems, such as artificial intelligence systems, large language models, and other trained models are used in user-facing roles. These systems may provide first-level user interactions. Current automated interaction system may generate unintended, inappropriate, or undesirable outputs.

### BRIEF DESCRIPTION OF THE DRAWINGS

Various examples will be described below with reference to the following figures.

FIG. 1 depicts an example system that provides output guardrails for an automated interaction, in accordance with some embodiments.

FIG. 2 depicts an example system for auto-evaluation, in accordance with some embodiments.

FIG. 3 depicts an example system that applies different output mitigations, in accordance with some embodiments.

FIG. 4 depicts a flowchart of an example method for automated interactions including output guardrails, in accordance with some embodiments.

FIG. 5 depicts an example system with a machine-readable medium that includes instructions for applying output guardrails to an automated interaction, in accordance with some embodiments.

FIG. 6 depicts a block diagram of a computing device, in accordance with some embodiments.

### DETAILED DESCRIPTION

The proliferation of automated interaction systems, such as chatbots, generative systems, and conversational systems, has led to efficient and enhanced communications. Current systems rely on configurations of compound systems, such as compound artificial intelligence (AI) systems including large language models (LLMs), to generate outputs to a user. Although automated interaction systems may provide a useful and expected output in most instances, compound AI systems may also produce unwanted or unexpected outputs. Current systems rely on configurations of underlying processes, such as configuration prompts for large language models (LLMs), in an attempt to mitigate these unwanted outputs. However, the current systems implementing LLMs will occasionally leak the underlying configuration instructions to the user. LLMs produce non-deterministic outputs, therefore leaking the configuration instructions in many different ways. The disclosed systems and methods provide output guardrails to mitigate any undesired outputs.

In some embodiments, the disclosed systems and methods apply one or more selected guardrail mitigations based on an output from a first compound AI system. An annotator may determine grouped outputs (e.g., concepts) and provide the grouped outputs to an auto-evaluator which identifies whether the initial output includes at least one target response. A respective mitigation (e.g., respective mitigation data) is applied for the identified target response and a revised output is generated. The disclosed systems and methods identify unwanted outputs (e.g., apply output guardrails) based on identification of concepts and known examples of unwanted outputs for each corresponding concept. A semantic similarity may be applied between known examples of unwanted outputs and real time session data to identify similar unwanted outputs. The disclosed systems and methods may apply concept-specific guardrails for a respective output, enabling a compound AI system to avoid displaying an unwanted output or executing unwanted loops.

In various embodiments, a system for implementing output guardrails is disclosed. The system includes a processor and a non-transitory memory that stores instructions. The instructions, when executed, cause the processor to receive, at a first compound AI system, a user input from a user device. The first compound AI system generates an initial output in response to the user input. The initial output is compared to a set of target response elements that each include at least a portion of a machine-generated utterance. When the initial output of the first compound AI system includes at least one target response element, a revised output is generated by applying a mitigation logic selected based on the at least one target response element. The revised output is transmitted to the user device. When the initial output does not include at least one target response element, the initial output is transmitted to the user device.

In various embodiments, a computer-implemented method is disclosed. The computer-implemented method includes steps of to receiving, at a first compound AI system, a user input from a user device and, in response to the user input, generating, by the compound AI system, an initial output. The computer-implemented method further includes steps of comparing the initial output to a set of target response element, generating a revised output by applying a mitigation logic selected based on the at least one target response element includes at least one target response element, and transmits the revised output to the user device. Each of the target response elements include at least a portion of a machine generated utterance. The computer-implemented method further includes a step of transmitting the initial output to the user device when the initial output does not include at least one target response element.

In various embodiments, a non-transitory computer-readable medium having instructions stored thereon is disclosed. The instructions, when executed by a processor, cause a device to perform operations including receiving, at a first compound AI system, a user input from a user device and, in response to the user input, generating, by the first compound AI system, an initial output. The instructions, when executed, further cause the device to perform operations including comparing the initial output to a set of target response elements, generating a revised output by applying a mitigation logic selected based on the at least one target response element when the initial output of the first compound AI system includes at least one target response element, and transmitting the revised output to the user device. Each of the target response elements include at least a portion of a machine generated utterance The instructions, when executed by the processor, further cause the device to perform operations including transmitting the initial output to the user device when the initial output does not include at least one target response element.

This description of the example embodiments is intended to be read in connection with the accompanying drawings that are to be considered part of the entire written description. Terms concerning data connections, coupling and the like, such as “connected,” “interconnected,” and/or “in signal communication with” refer to a relationship wherein systems or elements are electrically connected (e.g., wired, wireless) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

Furthermore, in the following, various embodiments are described with respect to methods and systems for implementation of output guardrails. In various embodiments, an initial input from a user is received by a first compound AI system. The compound AI system may include one or more automated elements, such as an automated interaction system, an LLM, etc. In response to receiving the user input, the first compound AI system may generate an initial output. The initial output is annotated by a response annotator by comparing the initial output to a set of target response elements. Each of the target response elements includes at least a portion of a machine-generated utterance. The target response elements may be representative of one or more concepts and/or may include examples of the one or more concepts. A concept may include a semantic description and one or more examples of unwanted output of the first compound AI system. When the initial output of the first compound AI system includes at least one target response element, a revised output is generated by applying a mitigation logic selected based on the at least one target response element. The revised output is transmitted to the user device. In some embodiments, the mitigation logic is unique for each concept (e.g., each target response element). When the initial output does not include at least one target response element, the initial output is transmitted to the user device.

In some embodiments, systems, and methods for implementing output guardrails include one or more trained or tuned models. The models may include one or more LLMs fine-tuned to generate an initial output. When the output of an LLM includes at least one target response element, mitigation logic is applied based on the at least one target response element. The mitigation logic may be used by the fine-tuned LLM to generate a revised output. The fine-tuned LLM may initiate one or more mitigation processes based on the included target response element. As another example, compound AI systems may include one or more mitigation logics configured to implement one or more output guardrail processes, such as modifying an input, extracting usable information from an input, etc.

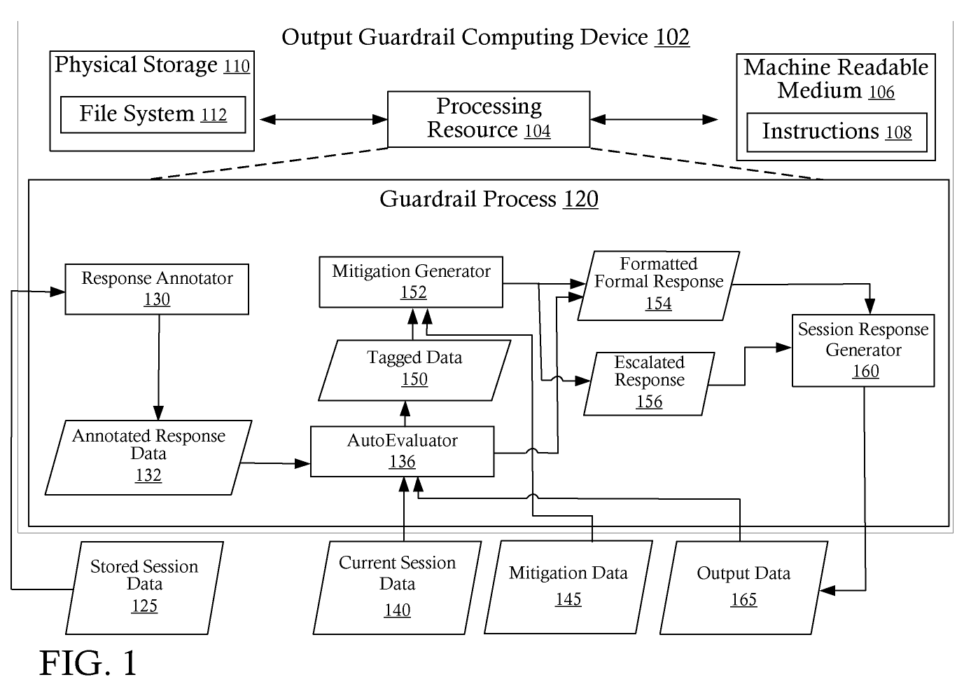

FIG. 1 depicts an example system 100 that provides output guardrails, for an automated interaction in accordance with some embodiments. In some embodiments, the system 100 prevents or minimizes unwanted outputs in automated interaction systems, such as chat systems between a user and an automated chatbot. The system 100 includes an output guardrail computing device 102 that generates a revised output when an initial output generated by an automated interaction system includes one or more target elements indicating an unwanted or undesirable output. The output guardrail computing device 102 includes a non-transitory machine-readable medium 106 that may include one or more of a random-access memory (RAM), read-only memory (ROM), electrically erasable programmable read-only memory (EEPROM), flash memory, hard disk, and/or any other suitable memory resource.

The processing resource 104 may execute instructions 108 (i.e., programming or software code) stored on machine-readable medium 106 to perform functions of the output guardrail computing device 102, such as receiving session data, annotating session data (e.g. conversational text) including a generated initial output from the first compound AI system, evaluating the initial output, comparing the initial output to a set of target response elements, generating and transmitting a revised output by applying mitigation logic when the initial output includes at least one target response element, or transmitting the initial output to the user device when the initial output does not include a target response element. The instructions 108 may include instructions for implementing one or more compound AI systems. In some embodiments, and as will be described further herein below, the output guardrail computing device 102 may execute one or more compound AI systems including one or more models, processes, or algorithms, such as a machine learning model, deep learning model, statistical model, etc. (e.g., as implemented as machine-readable instructions) to implement one or more mitigation processes, or implement one or more user interaction processes.

The output guardrail computing device 102 may also include other hardware components, such as physical storage 110. Physical storage 110 may include any physical storage device, such as a hard disk drive, a solid state drive, or the like, or a plurality of such storage devices ( e.g., an array of disks), and may be locally attached (i.e., installed) in the output guardrail computing device 102. In some implementations, physical storage 110 may be accessed as a block storage device.

In some cases, the output guardrail computing device 102 may also include a local file system 112 that may be implemented as a layer on top of the physical storage 110. For example, an operating system may be executing on the output guardrail computing device 102 (by virtue of the processing resource 104 executing certain instructions 108 related to the operating system) and the operating system may provide a file system 112 to store data on the physical storage 110.

The output guardrail computing device 102 may be in communication with a plurality of devices or systems over one or more network channels. For example, in various embodiments, the output guardrail computing device 102 may be in communication with one or more a cloud-based engines or servers such as one or more processing devices that may be provisioned for use (e.g., a web server, a processing server, etc.), a database, a workstation, and/or any other suitable system or device.

The output guardrail computing device 102 may implement one or more processes, such as guardrail process 120. In some embodiments, the guardrail process 120, such as a response annotator 130 of the guardrail process 120, receives stored session data 125 and, in response to receiving the stored session data 125, generates annotated response data 132. The stored session data 125 may include historical conversational text data. For example, the conversational text data may include, but is not limited to, historical transcripts of user-automated system interactions, call transcripts, and/or other interaction records stored in a database. The historical conversational text data may include, but is not limited to, text data in different languages (e.g., English, Spanish, French). In some embodiments, the historical conversational text data is text data received from a device. In some embodiments the text data is processed to remove personally identifying information or text related to sensitive topics. The text data may include multiple instances that can be received and processed. In some embodiments, and as described herein, the guardrail process 120 may annotate (e.g., label) portions of the stored session data 125 as “unwanted outputs” from an automated interaction system (e.g., a compound AI system).

In some embodiments, the response annotator 130 annotates portions of the text data to identify one or more concepts. A concept may represent a category of unwanted or undesirable outputs and may include a semantic description and a set of example unwanted utterances. In some examples, the concepts may be labeled as an incoming or outgoing concept. In some examples, the set of concepts and/or the corresponding example unwanted utterances may be outputs from a compound AI system, such as a compound AI system including an LLM. In some embodiments, the response annotator 130 may implement an LLM to annotate text data.

As one non-limiting example, a first concept may include “instruction leakage,” e.g., the inclusion of system instructions to the user. In some embodiments, leaked instructions may include confidential instructions that were meant to stay hidden from the user, such as, for example, instructions used to solely control the operation of the first compound AI system. Leaked instructions may include, for example, instructions that define a desired output from the first compound AI system, instructions preventing unwarranted or unnecessary transfers to a live agent, etc. For example, when a user request can be handled by an automated interaction system, the system instructions may indicate that the automated interaction system should attempt to solve the issue and/or answer the user’s question (e.g., desired utterance) prior to transferring the user to a live agent. In some instances, a user input may result in these instructions being provided to the user, e.g., an undesirable output, instead of the system attempting to address the user request.

An automated interaction system may be capable of generating multiple different instances of unwanted utterances or actions grouped within a single concept. For example, in the instruction leak example above, an automated interaction system may potentially produce multiple instances of unwanted outputs within the “instruction leak” concept. In some embodiments, one or more examples associated with a concept include text data generated during prior interactions with the automated interaction system, e.g., included within stored session data 125.

In some embodiments, the response annotator 130 generates annotated response data 132 that includes one or more identified concepts. The annotated response data 132 may include one or more example unwanted outputs that are stored in association with one or more concepts. The annotated response data 132 may include a semantic description of the concept and/or a set of example unwanted outputs associated with the concept. It will be appreciated that the annotated response data 132 may identify multiple concepts and/or include multiple corresponding sets of example unwanted outputs extracted from the text data of stored session data 125 and/or otherwise provided to the response annotator 130.

In some embodiments, an autoevaluator 136 receives annotated response data 132 and current session data 140 and generates tagged data 150. The annotated response data 132 may be stored in and/or retrieved from a database. In some embodiments, the current session data 140 may include conversational text data generated during a current interaction session between a user and an automated interaction system (e.g., current session data). For example, the current session data may include, but is not limited to, a user-automated agent (e.g., chatbot) text conversation, call transcripts, and/or other interaction records. The current session data may include utterances and/or interactions in one or more languages (e.g., English, Spanish, French).

In some embodiments the current session data is processed to remove personally identifying information and/or text related to sensitive topics. In some embodiments, the autoevaluator 136 receives current session data 140 and compares the current session data with each set of example unwanted outputs to determine whether any portion of the current session data corresponds to (e.g., semantically matches) one or more concepts identified by the response annotator 130. In some embodiments, the autoevaluator 136 compares the current session data 140 to at least one target response element including at least one example unwanted output associated with at least one concept identified by the response annotator 130. In some embodiments, the at least one target response element includes an identification of at least one of a predefined concept, a tone of the output, and/or a historical conversation element.

In some embodiments, the current session data and the at least one target response element may include and/or be converted to vector representations (e.g., text embedding vectors). A comparison of the text embedding vectors for the current session data and the at least one target response element may be performed to determine whether the current session data includes any portions that are semantically similar to the at least one target response element. In some embodiments, the vector representations are compared using a cosine similarity. Upon determination that the current session data 140 includes at least one target response element and is associated with a concept, the autoevaluator 136 generates tagged data 150. Tagged data 150 may include an indication that the current session data 140 includes at least one target response element. In some embodiments, the autoevaluator 136 implements a compound AI system, for example including an LLM, to execute one or more evaluation processes.

In some embodiments, mitigation generator 152 receives tagged data 150 and mitigation data 145 and may generate a formatted formal response 154 and/or an escalated response 156. Mitigation data 145 may be unique for each concept identifiable by the autoevaluator 136 and/or may be shared across one or more concepts. In some embodiments, the mitigation data 145 includes instructions to avoid outputting an unwanted utterance associated with the concept to the user. For example, the mitigation data 145 associated with the example concept “leaked instructions” may include instructions to reinstruct the first machine learning model to generate a new output and to avoid producing an output that includes the instructions provided to the first machine learning model to control the operation and/or define the desired output. In other embodiments, mitigation data 145 may include instructions to rerun the tagged data 150 by the first machine learning model and regenerate an output. It will be appreciated that any number of mitigation processes responsive to any type of identified target response element may be implemented. In some embodiments, the mitigation generator 152 implements a compound AI system, for example including an LLM, to execute one or more mitigation processes.

In some embodiments, the session response generator 160 receives the formatted formal response 154 and generates output data 165. The output data 165 may include conversational text output generated by the first compound AI system and processed by the mitigator 152. In some embodiments, the output data 165 is iteratively provided to the autoevaluator 136. When the autoevaluator 136 determines that the output data 165 still contains at least one target response element, the autoevaluator 136 generates additional tagged data 150 and iteratively repeats the above described mitigation process. The guardrail process 120 may be iteratively operated until no target response elements are identified in generated output data 165 and/or until the mitigation generator 152 applies the mitigation data 145 to the tagged data 150 a predetermined quantity of times. When mitigation generator 152 applies the mitigation data 145 to the tagged data 150 a predetermined quantity of times and the autoevaluator 134 continues to identify at least one target response element, the mitigation generator 152 may generate an escalated response 156. The escalated response 156 may be text data displayed to the user indicating that the first compound AI system will transfer the user to a live agent. It will be appreciated that any number of escalated responses, each responsive to one or more identified target response elements, may be generated.

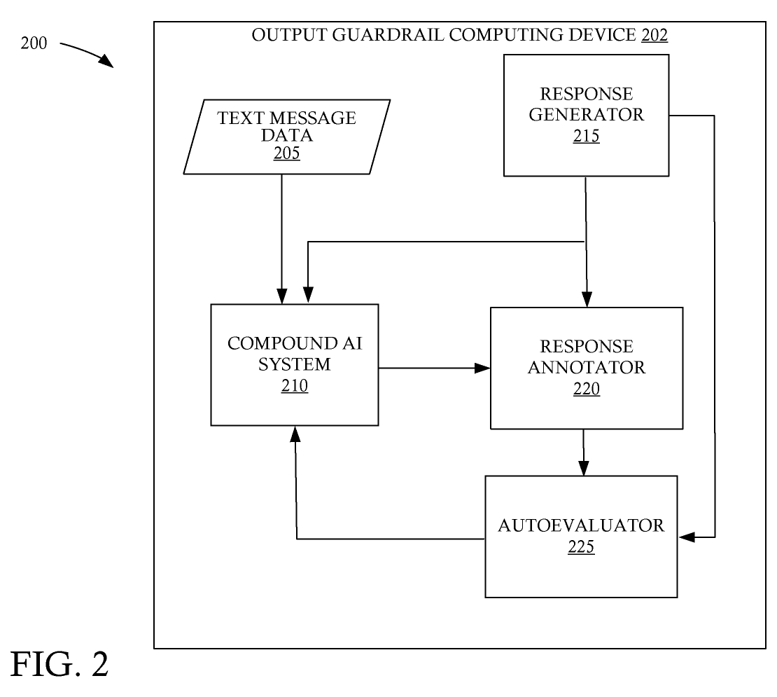

FIG. 2 depicts an example system 200 for autoevaluation, in accordance with some embodiments. In some embodiments, the system 200 includes output guardrail computing device 202. The output guardrail computing device 202 is similar to the output guardrail computing device 102 as discussed above with respect to FIG. 1, and similar description is not repeated herein. In some embodiments, components of system 200 may be implemented by the output guardrail computing device 102, such as by the processing resource 104 as part of a guardrail process 120.

In some embodiments, a compound AI system 210 receives text message data 205 and an output from a response generator 215. The text message data 205 may include conversational text data received from a user device. The text message data 205 may include a text transcript of a chat between a user and the compound AI system 210. In some embodiments, the compound AI system 210 receives an output from a response generator 215. The response generator 215 may include one or more compound AI systems, such as a first compound AI system. In some embodiments, the response generator 215 implements one or more compound AI systems including at least one LLM to generate an output to be transmitted to the compound AI system 210. The output may include inferences and/or embedding vectors generated by the LLM.

In some embodiments, the system 200 may include a response annotator 220. The response annotator 220 is similar to response annotator 130 as discussed above with respect to FIG. 1, and similar description is not repeated herein. The response annotator 220 receives an output from the compound AI system 210 and the response generator 215. The output from the compound AI system 210 can include transcripts of conversation text data between the compound AI system 210 and a user device. The response generator 215 may transmit the generated output to the response annotator 220. The output from response generator 215 may include embedding vectors of the generated text data output, which enable semantic searching to be used on the output from the response generator 215 by the response annotator 220. In some embodiments, semantic searching provides for efficient analysis of the outputs from the response generator 215. The response annotator 220 may utilize semantic searching to identify concepts and/or examples to include in a set of example unwanted utterances from the compound AI system(s) of the response generator 215.

In some embodiments, the system 200 includes an autoevaluator 225. The autoevaluator 225 is similar to the response autoevaluator 136 discussed above with respect to FIG. 1, and similar description is not repeated herein. The autoevaluator 225 may receive the output from the response annotator 220 and the output from the response generator 215. In some embodiments, the output of the response annotator 220 includes identified concepts or examples of the unwanted utterances from the compound AI systems of the response generator 215. The autoevaluator 225 stores received concepts and examples of unwanted utterances, for example, with a respective concept in a database. The autoevaluator 225 compares the concepts identified by the response annotator 220 with the output of the response generator 215 to determine when the embedding vectors of the text data produced from the response generator 215 and the examples identified by the response annotator 220 are semantically close. In some embodiments, the embedding vectors may be compared by a similarity comparison, such as a cosine similarity. When the autoevaluator 225 determines that a portion of the text data is similar (e.g., belongs to the same concept) the autoevaluator 225 stores the output from the response generator 215 in a database in relation to the concept. In some embodiments, the autoevaluator 225 sends an output to the compound AI system 210, which outputs conversation text data (e.g., utterances) to a user device. In some embodiments, the compound AI system 210 includes a chatbot and/or other interaction system. The compound AI system 210 may receive additional inputs (e.g., user utterances) from the user device and provide a modified text transcript including updated conversation text data to the response annotator 220. In some embodiments, the response annotator 220 may iteratively analyze the conversation text data as described as the compound AI system 210 receives text message data 205 and sends to the autoevaluator 225 to be stored in a database of new concepts or example utterances are determined. In some embodiments, the text message data 205 is stored as historical data to be reviewed and compared to live session text message data. In some embodiments, the response annotator 220 and autoevaluator 225 applies the same concept for the entirety of the conversation between the compound AI system 210 and the received text message data 205.. In some embodiments, the response annotator 220 and autoevaluator 225 determines multiple concepts for the conversation between the compound AI system 210 and the received text message data 205. In some

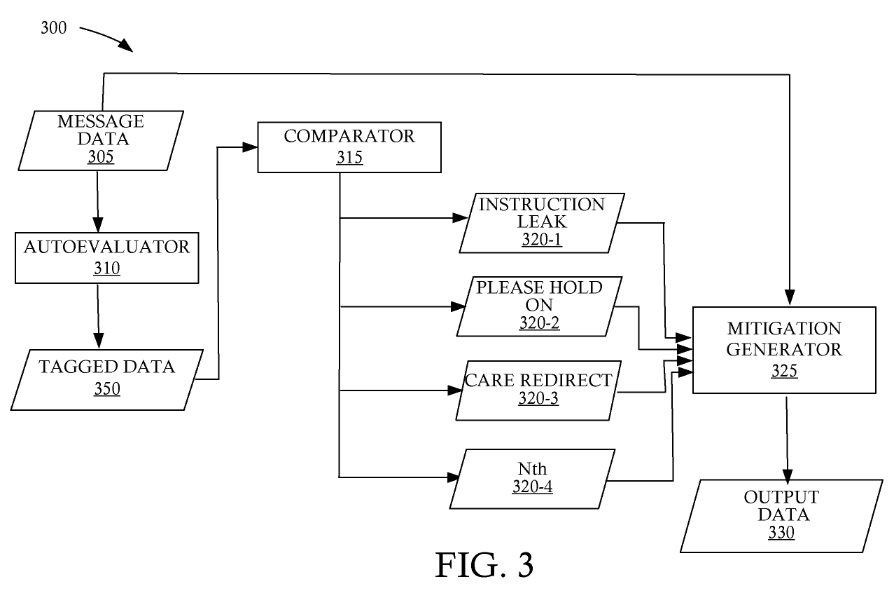

FIG. 3 depicts an example system 300 that applies different output mitigation options, in accordance with some embodiments. In some embodiments, one or more components of the system 300 may be implemented by the output guardrail computing device 102 discussed above, such as by the processing resource 104 as part of a guardrail process 120. The system 300 may include an autoevaluator 310 similar to autoevaluator 136 and autoevaluator 225 as discussed above with respect to FIGS. 1 and 2, respectively. The autoevaluator 310 may access a database storing previously identified concepts and examples of unwanted utterances for each concept as discussed above with respect to FIGS. 1 and 2. They system 300 may further include a mitigation generator 325 similar to mitigation generator 152 as discussed above with respect to FIG. 1. The mitigation generator 325 may generate a formatted formal response and/or escalated response as discussed above with respect to FIG. 1.

In some embodiments, the autoevaluator 310 receives message data 305 including at least a portion of an on-going text conversation session between a user device and a chatbot. The autoevaluator 310 may generate tagged data 150. The message data 305 may include text data including one or more messages or responses from a user device. The message data 305 may include embedding vectors representative of the corresponding text data. In some embodiments, the autoevaluator 310 compares the message data 305 (e.g., embedding vectors representative of the text data) with example utterances for one or more concepts (e.g., embedding vectors representative of example unwanted inputs for one or more utterances that have been previously stored in the database). In some embodiments, a comparison may include a similarity, such as a cosine similarity. When the comparison (e.g., similarity) meets a predetermined threshold, the message data 305 is identified as similar to stored examples of unwanted utterances for each identified concept in the database and the autoevaluator 301 generates tagged data 350. The tagged data 350 indicates that the message data 305 includes text data associated with or included within an identified concept.

In some embodiments, a comparator 315 receives the tagged data 350 and determines one or more mitigation processes to apply for the respective identified concept. For example, in some embodiments, the mitigation processes may include an instruction leak mitigation process 320-1, a please hold on mitigation process 320-2, a care redirect mitigation process 320-3, and an Nth process 320-4 (representative of one or more additional mitigation processes) (collectively referred to herein as “mitigation processes 320”). One or more of the mitigation processes 320 are selected based on one or more concepts identified by the tagged data 350. Each of the mitigation processes 320 may include unique instructions for addressing and/or mitigating an utterance within a concept identified in the tagged data 350.

For example, in some embodiments, an instruction leak mitigation process 320-1 may include instructions to re-prompt a compound AI system when an output includes system instructions in order to avoid relaying (e.g., leaking) the corresponding instructions to the user. As another example, in some embodiments, a please hold on mitigation process 320-2 includes instructions to cause a compound AI system to produce a different output when a predetermined utterance or concept is detected. For example, the “please hold on” concept may include example unwanted utterances that instruct the user to “wait” or “hold on,” implying the compound AI system is generating a response or trying to determine an answer for a question from a user, when, in actuality, the “please hold on” output represents a completed turn (e.g., complete utterance) of the compound AI system and no further action is actually taken. The please hold on mitigation process 320-2 may include instructions to blindly (e.g., without modification or analysis) retry the input from the user to assess whether the compound AI system produces a revised output or the same output. The please hold on mitigation process 320-2 may include further instructions to reformat or modify the input when the compound AI system produces a repeat “please hold on” response. As yet another example, in some embodiments, a care redirect mitigation process 320-3 includes instructions to prevent redirecting a user to the same interactive system. The concept “care redirect” may include example unwanted utterances that cause a compound AI system to identify itself as a different interactive system, for example, informing the user that the user will be assisted by a different system when the compound AI system is the correct system for addressing the user concern. The care redirect mitigation process 320-3 may include instructions to re-prompt the compound AI system with a targeted instruction to remind the compound AI system it is the correct system for assisting the user, resulting in generation of a desired output.

In some embodiments, mitigation generator 325 receives the mitigation processes 320 and message data 305 and generates output data 330. The mitigation generator 325 may include a compound AI system that produces output data 330 corresponding to an output in response to the user input of message data 305 and the instructions provided by mitigation processes 320.

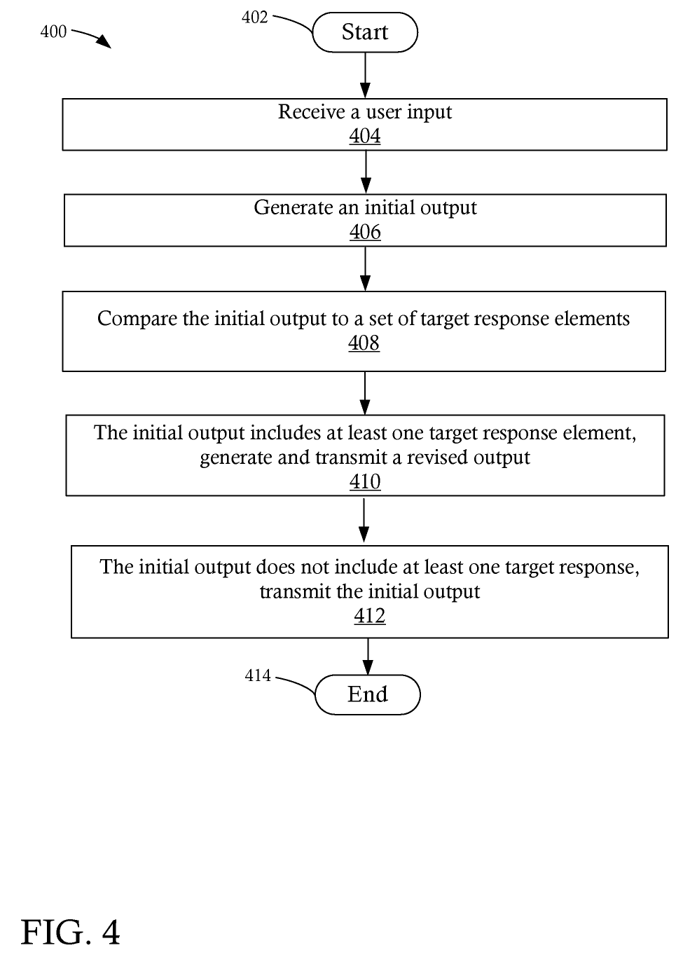

FIG. 4 is a flow diagram depicting an example method. In some embodiments, one or more blocks of the method may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the method may be combined.

The method shown in FIG. 4 may be implemented in the form of executable instructions stored on a machine-readable medium and executed by a processing resource and/or in the form of electronic circuitry. For example, aspects of the method may be described below as being performed by a mitigation process, an example of which may be the guardrail process 120 running on a hardware processing resource 104 of the output guardrail computing device 102 described above. Additionally, other aspects of the method described below may be described with reference to other elements shown in FIG. 1 for non-limiting illustration purposes.

FIG. 4 depicts a flowchart of an example method 400 for implementing output guardrails, in accordance with some embodiments. Method 400 starts at block 402 and continues to block 404, where a user input from a user device is received at a first compound AI system. The user input may be an initial input (e.g., first input received), a subsequent input (e.g., input received as part of an on-going interaction), a responsive input (e.g., input provided in response to a system prompt), etc., intended for the first compound AI system. The first compound AI system may include and/or embody a chatbot or other interactive model. The user input may be received from any suitable system, such as a user device, web server, etc.

At block 406, an initial output is generated by the first compound AI system based on the user input. The initial output may include or be representative of text data representing a response or utterance from the first compound AI system to the user device. The utterance may include text data to be displayed via the user device, audio data to be played by the user device, etc.

At block 408, the initial output is compared to a set of target elements to determine whether the utterance is an unwanted utterance. The set of target elements include examples of identified concepts each associated with a set of example unwanted utterances. In some embodiments, the initial output may be semantically compared to sets of target elements each associated with one or more concepts. Example utterances defining each concept may be stored in a database.

At block 410, when it is determined that the initial output includes at least one target response element, a revised output is generated. The revised output can be generated based on mitigation data received that is specific for the identified concept of the one target response element. Each concept has a unique mitigation process that is implemented to generate a revised output that produces a desired utterance from the first trained model. After the revised output is generated, the revised output is transmitted to the user and displayed on a user device. The user can view and interact with the output by responding or following any instructions that are included in the output.

At block 412, when it is determined that the user input does not include at least one target response, the initial output is transmitted to the user. An initial output lacking any identification of at least one target response does not include any portions related to any identified concept. In some embodiments, the initial output may be labeled directly as a desired utterance and transmitted to the user and displayed on a user device. At block 414, the method 400 ends.

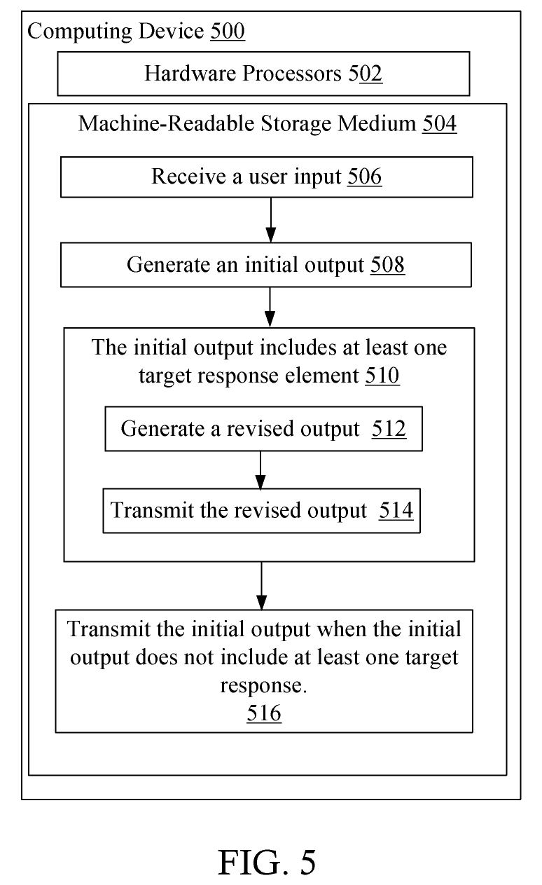

FIG. 5 depicts an example system 500 for generating output guardrails that includes a machine-readable media 504 encoded with example instructions executable by processing resource 502. In some implementations the system 500 may be useful for implementing aspects of the system 100 of FIG. 1, aspects of system 200 of FIG. 2 for auto-evaluation, system 300 of FIG. 3 that applies different output mitigation options, or performing the aspects of method 400 of FIG. 4. For example, the instructions encoded on machine-readable media 504 may be included in instructions 108 of FIG. 1. In some implementations, functionality described with respect to FIG. 1 may be included in the instructions encoded on machine-readable media 504.

The processing resource 502 may include a microcontroller, a microprocessor, central processing unit core(s), an ASIC, an FPGA, and/or other hardware device suitable for retrieval and/or execution of instructions from the machine-readable media 504 to perform functions related to various examples. Additionally, or alternatively, the processing resource 502 may include or be coupled to electronic circuitry or dedicated logic for performing some or all of the functionality of the instructions described herein.

The machine-readable media 504 may be any medium suitable for storing executable instructions, such as RAM, ROM, EEPROM, flash memory, a hard disk drive, an optical disc, or the like. In some example implementations, the machine-readable media 504 may be a tangible, non-transitory medium. The machine-readable media 504 may be disposed within the system 500 in which case the executable instructions may be deemed installed or embedded on the system. Alternatively, the machine-readable media 504 may be a portable (e.g., external) storage medium, and may be part of an installation package.

As described further herein below, the machine-readable media 504 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 4.

The machine-readable media 504 includes instructions 506-522. Instructions 506, when executed, cause the processing resource 502 to receive a user input. Instructions 508, when executed cause the processing resource 502 to generate an initial input. Instructions 510, when executed, cause the processing resource 502 to execute instructions 512 and 514 when the initial target includes at least one target response element. Instructions 512, when executed, cause the processing resource 502 to generate a revised output. Instructions 514, when executed cause, the processing resource 502 to transmit the revised output. Instructions 516, when executed cause, the processing resource 502 to transmit the initial output when the initial output does not include at least one target response.

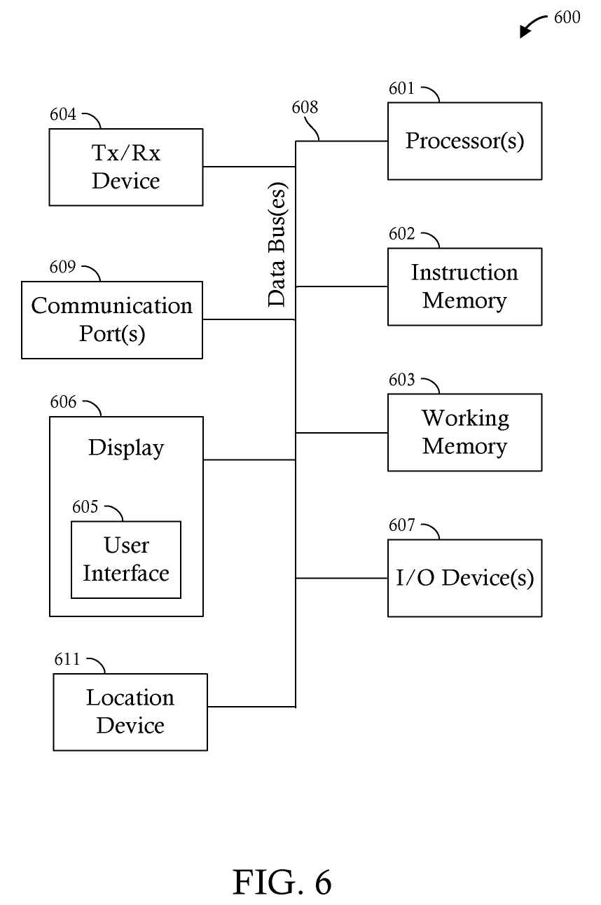

As shown in FIG. 6, the computing device 600 may include one or more processing resources 502, instruction memory 604, working memory 606, input/output devices 608, transceiver 610, communication ports 612, display 614, and/or any other suitable elements each operatively coupled to one or more data buses 620. The data buses 620 allow for communication among the various components. The data buses 620 may include wired, or wireless, communication channels.

The one or more processing resources 602 may include any processing circuitry operable to control operations of the computing device 600. In some embodiments, the one or more processing resources 602 include one or more distinct processors, each having one or more cores (e.g., processing circuits). Each of the distinct processors may have the same or different structure. The one or more processing resources 602 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 602 may also be implemented by a controller, a microcontroller, an application specific integrated circuit (ASIC), a field programmable gate array (FPGA), a programmable logic device (PLD), etc.

In some embodiments, the one or more processing resources 602 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 604 may store instructions that are accessed (e.g., read) and executed by at least one of the one or more processing resources 602. For example, the instruction memory 604 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 602 may perform a certain function or operation by executing code, stored on the instruction memory 604, embodying the function or operation. For example, the one or more processing resources 602 may execute code stored in the instruction memory 604 to perform one or more of any function, method, or operation disclosed herein.

Additionally, the one or more processing resources 602 may store data to, and read data from, the working memory 606. For example, the one or more processing resources 502 may store a working set of instructions to the working memory 606, such as instructions loaded from the instruction memory 604. The one or more processing resources 602 may also use the working memory 606 to store dynamic data created during one or more operations. The working memory 606 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 604 and working memory 606, it will be appreciated that the computing device 600 may include a single memory unit that operates as both instruction memory and working memory. Further, although embodiments are discussed herein including non-volatile memory, it will be appreciated that computing device 600 may include volatile memory components in addition to at least one non-volatile memory component.

In some embodiments, the instruction memory 604 and/or the working memory 606 includes an instruction set, in the form of a file for executing various methods, such as methods for image annotation through implementation of localized embeddings, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter converts the instruction set into machine executable code for execution by the one or more processing resources 602.

The input/output devices 608 may include any suitable device that allows for data input or output. For example, the input/output devices 608 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 610 and/or the communication port(s) 612 allow for communication with a network. For example, if a communication network is a cellular network, the transceiver 610 allows communications with the cellular network. In some embodiments, the transceiver 610 is selected based on the type of the communication network the computing device 600 will be operating in. The one or more processing resources 602 are operable to receive data from, or send data to, a network via the transceiver 610.

The communication port(s) 612 may include any suitable hardware, software, and/or combination of hardware and software that is capable of coupling the computing device 600 to one or more networks and/or additional devices. The communication port(s) 612 may be arranged to operate with any suitable technique for controlling information signals using a desired set of communications protocols, services, or operating procedures. The communication port(s) 612 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 612 allows for the programming of executable instructions in the instruction memory 604. In some embodiments, the communication port(s) 612 allow for the transfer (e.g., uploading or downloading) of data, such as machine learning model training data.

In some embodiments, the communication port(s) 612 couples the computing device 600 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 610 and/or the communication port(s) 612 utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 614 may be any suitable display and may display the user interface 616. The user interfaces 616 may enable user interaction with the annotated reference data and positional encodings identifying the location of each object of the plurality of objects of the reference image. For example, the user interface 616 may be a user interface for an application of a network environment operator that allows a user to view and interact with the operator’s website. In some embodiments, a user may interact with the user interface 616 by engaging the input/output devices 608. In some embodiments, the display 614 may be a touchscreen, where the user interface 616 is displayed on the touchscreen.

The display 614 may include a screen such as, for example, a Liquid Crystal Display (LCD) screen, a light-emitting diode (LED) screen, an organic LED (OLED) screen, a movable display, a projection, etc. In some embodiments, the display 614 may include a coder/decoder, also known as Codecs, to convert digital media data into analog signals. For example, the visual peripheral output device may include video Codecs, audio Codecs, or any other suitable type of Codec.

In some embodiments, the computing device 600 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub- modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 600 may be a computer, a workstation, a laptop, a server such as a cloud-based server, or any other suitable device. In some embodiments, the computing device 600 is a server that includes one or more processing units, such as one or more graphical processing units (GPUs), one or more central processing units (CPUs), and/or one or more processing cores. The computing device 600 may, in some embodiments, execute one or more virtual machines. In some embodiments, processing resources (e.g., capabilities) of the computing device 600 are offered as a cloud-based service (e.g., cloud computing).

Although embodiments are illustrated herein including certain systems and/or devices, it will be appreciated that additional systems, servers, storage mechanism, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

Although embodiments are illustrated herein including certain systems and/or devices, it will be appreciated that additional systems, servers, storage mechanisms, etc. may be included. In addition, although embodiments are illustrated herein as having individual, discrete systems, it will be appreciated that, in some embodiments, one or more systems may be combined into a single logical and/or physical system. Similarly, although embodiments are illustrated as having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions, that when executed, cause the processor to:
receive, at a compound system, a user input from a user device;
in response to the user input, generate, by the compound system, an initial output;
compare the initial output to a set of target response elements, wherein each of the target response elements include at least a portion of a machine generated utterance;
when the initial output of the compound system includes at least one target response element:
generate a revised output by applying a mitigation logic selected based on the at least one target response element; and
transmit the revised output to the user device; and
when the initial output does not include at least one target response element, transmit the initial output to the user device.

2. The system of claim 1 wherein, to compare the initial output to the set of target response elements, the instructions, when executed, cause the processor to:
generate a first data vector of the initial output;
generate a second data vector of each of the set of target response elements;
generate a cosine similarity between the first data vector and the second data vector of each of the set of target response elements; and
determine the initial output of the compound system includes the at least one target response element based on the generated cosine similarities.

3. The system of claim 2, wherein the instructions, when executed, cause the processor to determine the initial output of the compound system includes the at least one target response element when the cosine similarity at least meets a predetermined threshold.

4. The system of claim 1 wherein a machine learning model of the compound system generates the initial output, and wherein, to apply the mitigation logic, the instructions, when executed, cause the processor to:
generate instructions to reinstruct the machine learning model to generate a second output; and
transmit the instructions to the compound system, wherein the revised output comprises the second output generated by the machine learning model.

5. The system of claim 1, wherein the instructions further instruct the machine learning model to not generate the initial output.

6. The system of claim 1 wherein, to apply the mitigation logic, the instructions, when executed, cause the processor to:
select one of a plurality of mitigation processes based on the portion of the machine generated utterance corresponding to the at least one target response element; and
apply the selected one of the plurality of mitigation processes to generate the revised output.

7. The system of claim 6, wherein the instructions, when executed, cause the processor to receive conversational text data from a database in response to the selection of the one of the plurality of mitigation processes, and generate the revised output to include the conversational text data.

8. The system of claim 6, wherein the instructions, when executed, cause the processor to remove text data from the initial output in response to the selection of the one of the plurality of mitigation processes, wherein the revised output is the initial output with the removed text data.

9. A computer implemented method comprising:
receiving, at a compound system, a user input from a user device;
in response to the user input, generating, by the compound system, an initial output;
comparing the initial output to a set of target response elements, wherein each of the target response elements include at least a portion of a machine generated utterance;
when the initial output of the compound system includes at least one target response element:
generating a revised output by applying a mitigation logic selected based on the at least one target response element; and
transmitting the revised output to the user device; and
when the initial output does not include at least one target response element, transmitting the initial output to the user device.

10. The method of claim 9 wherein comparing the initial output to the set of target response elements comprises:
generating a first data vector of the initial output;
generating a second data vector of each of the set of target response elements;
generating a cosine similarity between the first data vector and the second data vector of each of the set of target response elements; and
determining the initial output of the compound system includes the at least one target response element based on the generated cosine similarities.

11. The method of claim 10 comprising determining the initial output of the compound system includes the at least one target response element when the cosine similarity at least meets a predetermined threshold.

12. The method of claim 9 wherein a machine learning model of the compound system generates the initial output, and wherein applying the mitigation logic comprises:
generating instructions to reinstruct the machine learning model to generate a second output; and
transmitting the instructions to the compound system, wherein the revised output comprises the second output generated by the machine learning model.

13. The method of claim 9 wherein the instructions further instruct the machine learning model to not generate the initial output.

14. The method of claim 9 wherein applying the mitigation logic comprises:
selecting one of a plurality of mitigation processes based on the portion of the machine generated utterance corresponding to the at least one target response element; and
applying the selected one of the plurality of mitigation processes to generate the revised output.

15. The method of claim 14 comprising receiving conversational text data from a database in response to the selection of the one of the plurality of mitigation processes, and generating the revised output to include the conversational text data.

16. The method of claim 14 comprising removing text data from the initial output in response to the selection of the one of the plurality of mitigation processes, wherein the revised output is the initial output with the removed text data.

17. A non-transitory computer-readable medium having instructions stored thereon, wherein the instructions, when executed by at least one processor, cause at least one device to perform operations comprising:
receiving, at a compound system, a user input from a user device;
in response to the user input, generating, by the compound system, an initial output;
comparing the initial output to a set of target response elements, wherein each of the target response elements include at least a portion of a machine generated utterance;
when the initial output of the compound system includes at least one target response element:
generating a revised output by applying a mitigation logic selected based on the at least one target response element; and
transmitting the revised output to the user device; and
when the initial output does not include at least one target response element, transmitting the initial output to the user device.

18. The non-transitory computer-readable medium of claim 17 wherein comparing the initial output to the set of target response elements comprises:
generating a first data vector of the initial output;
generating a second data vector of each of the set of target response elements;
generating a cosine similarity between the first data vector and the second data vector of each of the set of target response elements; and
determining the initial output of the compound system includes the at least one target response element based on the generated cosine similarities.

19. The non-transitory computer-readable medium of claim 18 wherein the operations further comprise determining the initial output of the compound system includes the at least one target response element when the cosine similarity at least meets a predetermined threshold.

20. The non-transitory computer-readable medium of claim 17 wherein a machine learning model of the compound system generates the initial output, and wherein applying the mitigation logic comprises:
generating instructions to reinstruct the machine learning model to generate a second output; and
transmitting the instructions to the compound system, wherein the revised output comprises the second output generated by the machine learning model.
